(19) United States
(12) Patent Application Publication
(10) Pub. No.: US 2016/0361739 A1
(43) Pub. Date: Dec. 15, 2016

(54) Drain Clearing Kit and Method

(71) Applicants: Richard Wescott, Franklin, KY (US); Gordon Ragland, Russellville, KY (US)

(72) Inventors: Richard Wescott, Franklin, KY (US); Gordon Ragland, Russellville, KY (US)

(21) Appl. No.: 15/144,111

(22) Filed: May 2, 2016

Related U.S. Application Data
(60) Provisional application No. 62/175,517, filed on Jun. 15, 2015.

(51) Int. Cl. B08B 9/032; E03C 1/306

(52) U.S. Cl. CPC B08B 9/0321; E03C 1/306

(57) ABSTRACT

A drain clog clearing kit and method are provided that utilize a pressurized water line to evacuate clogs downstream of a sink drain. The kit comprises a quick disconnect hose fitting that couples to a complimentary fitting on a fluid hose used to force water into the sink and downstream pipe. The quick disconnect hose fitting has a male distal end, a widened proximal end, and a pathway therethrough. The fitting secures to a pipe adapter either directly or via a threaded cap, whereafter the pipe adapter is threadably secured to a drain pipe requiring maintenance. Securing the kit elements in series, a user can secure a water hose to the quick disconnect fitting and force water into the drain pipe downstream of the fitting. The forced fluid flow acts to break up clogs, thereby clearing blockages not easily cleared otherwise.

### CROSS REFERENCE TO RELATED APPLICATION

This application claims the benefit of U.S. Provisional Application No. 62/175,517 filed on Jun. 15, 2015. The above identified patent application is herein incorporated by reference in its entirety to provide continuity of disclosure.

### BACKGROUND OF THE INVENTION

### Field of the Invention

The present invention relates to attachable assemblies for clearing clogged sink pipes. More specifically, present invention relates to a kit for securing a quick disconnect fitting to a drain pipe, and thereafter securing a water hose to the quick disconnect fitting to forcibly clear drains downstream of the drain pipe. A kit and method are disclosed.

When sink drain pipes become clogged, it can be difficult to clear the clog without special tools. Options include using declogging chemicals, which are poured into the drain to destroy the clogging debris. Other options involve removing the drain pipe trap and physically removing the clog with a snake tool or the like. The first option involves harsh chemicals that can be dangerous to users if contacted or ingested. The second option involves using a physical tool that is inserted into the drain pipe interior. The results of this latter option can be messy, and require special tools in a drain snake.

The present invention contemplates a new method of clearing sink drain pipes using pressurized water. A garden hose or similar water hose is connected to the drain pipe downstream of a trap. The hose is affixed to the drain and sealed thereto as water is forced downstream into the drain pipe. The water forcibly removes clogs without using chemicals or physical tools. To facilitate this, an assembly or kit is provided for quickly affixing and removing a water hose to the drain pipe. In particular, the kit includes one or more pipe adapters having a threaded ends. A pipe adapter of suitable size is threadably secured to the drain pipe, whereafter a quick disconnect fitting is threadably attached to the opposite end of the pipe adapter. A water hose is coupled to the quick disconnect fitting, whereafter a pressurized stream of water can flow into the drain to remove clogs. Because physical tools are not involved, difficult drain pipe geometry and elbows therealong can easy be cleared where using hand tools would prove difficult.

### SUMMARY OF THE INVENTION

The following summary is intended solely for the benefit of the reader and is not intended to be limiting in any way. The present invention provides a new drain clog clearing kit and method, whereby the same can be utilized for clearing drain clogs in downstream pipes using a water source and a water hose.

It is therefore an object of the present invention to provide a new and improved drain clog clearing kit and method that has all of the advantages of the prior art and none of the disadvantages.

It is another object of the present invention to provide a drain clog clearing kit and method that can clear clogged sink drains using water pressure rather than physical tools or toxic chemicals.

Another object of the present invention is to provide a drain clog clearing kit that enables connection of a water line thereto for the purposes of forcibly clearing a clog downstream of the connection using water pressure.

Another object of the present invention is to provide a drain clog clearing kit that comprises a quick disconnect hose fitting, one or more pipe adapters, and an optional threaded cap. The kit enables a hose with a complimentary quick disconnect fitting to secure to the quick disconnect fitting of the kit after being installed on a drain pipe.

Another object of the present invention is to provide a drain clog clearing kit, whereby the quick disconnect fitting is adapted to couple to a complimentary fitting on a fluid hose without additional tools, thereby securing the fluid hose to the quick disconnect hose fitting when the quick disconnect hose fitting and the complimentary fitting are engaged.

Another object of the present invention is to provide a drain clog clearing kit in which the quick disconnect hose fitting has a male distal end, a widened proximal end, and a fluid pathway therethrough.

Another object of the present invention is to provide a drain clog clearing kit, whereby the optional threaded cap has an interior shoulder supporting a gasket and an upstanding sidewall with interior threads. The threaded cap also has an open interior, whereby the distal end of the quick disconnect hose fitting extends therethrough, and whereby the interior shoulder is sized to bear against the widened proximal end of the quick disconnect hose fitting.

Another object of the present invention is to provide a drain clog clearing kit in which the pipe adapter has a first end and a second end. The first end of the pipe adapter has threads adapted to connect to a collar on a sink drain pipe or directly into the sink drain pipe using the drain pipe threads. The second end of the pipe adapter has threads adapted to connect to the threads of the threaded cap or connect directly to the threaded proximal end of the quick disconnect fitting.

Another object of the present invention is to provide a drain clog clearing kit, whereby the quick disconnect hose fitting further comprises an elongated plunger that is adapted to engage an interior of a compression fitting of the complimentary fitting. The plunger has a distal end with a notch extending therearound, whereby the compression fitting of the complimentary fitting secures the plunger therein and secures over the notch of the plunger.

Another object of the present invention is to provide a drain clog clearing method, first comprising the steps of securing a first end of a pipe adapter to sink drain pipe to threadably secure the first end of the pipe adapter thereto. The next step is securing a quick disconnect hose fitting to a threaded second end of the pipe adapter using. The threaded quick disconnect hose fitting preferably has threads that engage the threaded second end of the pipe adapter, or an intermediate threaded cap is used therebetween. Next, a fluid hose is affixed to the quick disconnect hose fitting, whereby the fluid hose has a complimentary fitting adapted to operably secure to the quick disconnect hose fitting. Finally, fluid is forced through the fluid hose, through the quick disconnect hose fitting, into the pipe adapter, and into the sink drain to forcibly clear blockages therein.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 illustrates an assembled view of an embodiment of the drain clearing kit of the present invention, connected to a drain pipe.

FIG. 2 provides an exploded view of the elements of the drain clearing kit.

FIG. 3 shows another view of the drain clearing kit of the present invention in a working state, whereby a water line is connected thereto to clear the drain pipe downstream.

FIG. 4 illustrates an exploded view of an embodiment of the drain clearing kit of the present invention.

FIG. 5 shows a side view of an embodiment of the quick disconnect fitting of the present invention.

FIG. 6 shows a view of the drain clearing kit of the present invention in a working state, whereby the pipe adapter is directly connected to a drain pipe and the quick disconnect fitting is directly connected to the pipe adapter.

### DETAILED DESCRIPTION OF THE INVENTION

Reference is made herein to the attached drawings. Like reference numerals are used throughout the drawings to depict like or similar elements of the drain clog clearing kit and method of the present invention. For the purposes of presenting a brief and clear description of the present invention, the preferred embodiment will be discussed as used for clearing drain clogs using pressurized water. The figures are intended for representative purposes only and should not be considered to be limiting in any respect.

The present invention provides a new and improved method and means for clearing a clogged drain pipe of a sink, whereby the clog is cleared using pressurized water inserted into the drain. The present invention eliminates the need to insert any tools into the drain, or resort to chemicals to deteriorate the clog within the drain. Rather, the present invention provides a coupling that enables a water hose, such as a garden hose or the like, to be securely affixed to the drain and used to clear the clog therein using pressurized water from the hose.

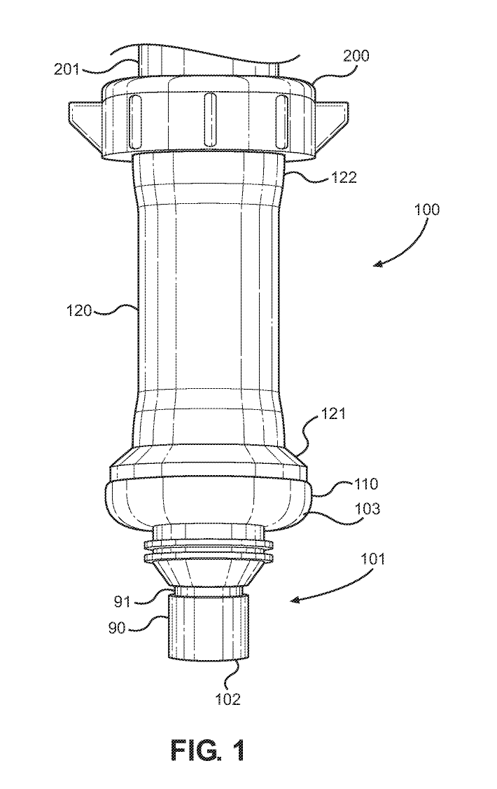

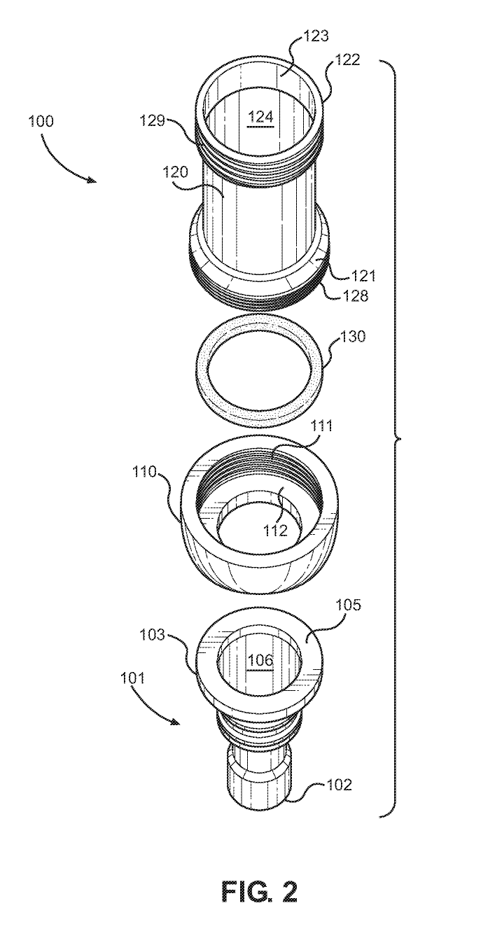

Referring now to FIGS. 1 and 2, there are shown views of an embodiment of the present invention in a working and exploded state. In this embodiment, the kit includes an assembly comprising a quick disconnect fitting 101, an elongated pipe adapter 100, and a threaded cap 110 for securing the fitting 101 to the pipe adapter 100. The pipe adapter 100 is secured to a drain pipe 201 in use after the trap of a sink is removed between the sink outlet and the drain pipe 201 or after the drain pipe is otherwise exposed. The pipe adapter 100 may be supplied with a collar nut or additional threaded cap 110 to secure the pipe adapter 100 to the drain pipe 201. Alternatively, the pipe adapter 100 may threadably secure directly to the drain pipe 201 using one of internal threads or a collar nut 200 disposed on the drain pipe 201 that is otherwise used to connect the drain pipe 201 to other pipe sections.

The quick disconnect hose fitting 101 is a fitting that is adapted to operably couple to a complimentary fitting on a fluid hose without tools. The fitting 101 includes a male distal end 102, a body portion, and a fluid pathway 106 therethrough. The body portion preferably comprises a widened proximal end 105 and an outer edge 103 along the proximal end 105. The proximal end 105 is adapted to be placed in connection with the pipe coupler 120 and threadably connect thereto using threads on the outer edge 103 of the fitting 101, or via the optional threaded cap 110.

The male distal end 102 of the fitting 101 is adapted to couple to a complimentary quick disconnect fitting on a fluid hose without requiring tools or a securing nut. In one embodiment, the male end 102 of the quick disconnect fitting 101 further comprises an elongated plunger 90 that is adapted to engage the interior of a compression fitting of the complimentary fitting on a water hose. The plunger 90 has a distal end with a notch 91 extending therearound and at the base of the plunger 90. The compression fitting of the attached hose secures the plunger 90 within its interior and secures over the notch 91 of the fitting 101 to operably secure and couple the two together while the fitting and hose are in use. The two couple together without tools, whereby a sliding portion of the compression fitting allows the plunger 90 to insert therein, whereafter the same sliding portions secures thereover and the plunger 90 and compression fitting are secured together. Once secured together, water can freely pass from the hose and through the fitting interior 106 without leakage.

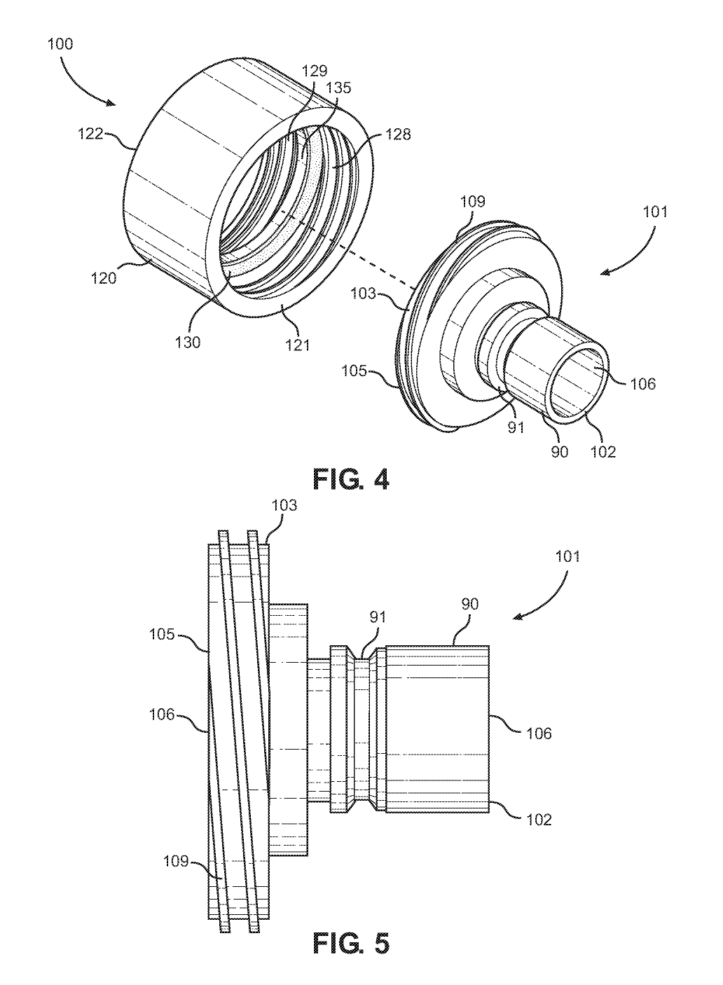

To secure the quick disconnect fitting 101 to the pipe adapter 100, the fitting 101 may include machine threads therealong, or an optional threaded cap 110 may be used to secure the fitting 101 to the pipe adapter 100. The optional threaded cap 110 includes an open interior, a shoulder portion 112, and sidewalls. Along the interior of the sidewalls are preferably machine threads 111, which is adapted to secure to complimentary threads 128 along the second end 121 of the pipe adapter 100. The widened proximal end 105 of the quick disconnect fitting 101 is positioned within the interior of the threaded cap 110, whereby the shoulder 112 of the threaded cap sandwiches the proximal end 105 of the fitting to the end 121 of the pipe adapter. Between the cap 110 and the fitting 101 is a gasket 130 to prevent leakage from the assembly once connected. The distal end 102 of the quick disconnect fitting 101 extends through the open interior of the threaded cap 110, while the interior shoulder 112 is sized to bear against the widened proximal end 105 of the quick disconnect hose fitting 101 when the cap 110 is secured to the pipe adapter 100. The embodiment of the present invention in which a threaded cap 110 is utilized is shown in FIGS. 1-3. The embodiment in which no threaded cap is deployed is shown in FIGS. 4-6.

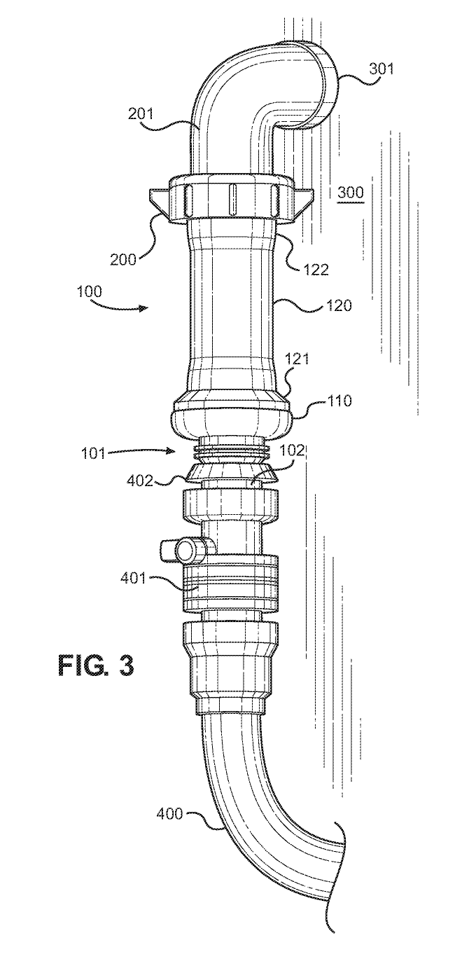

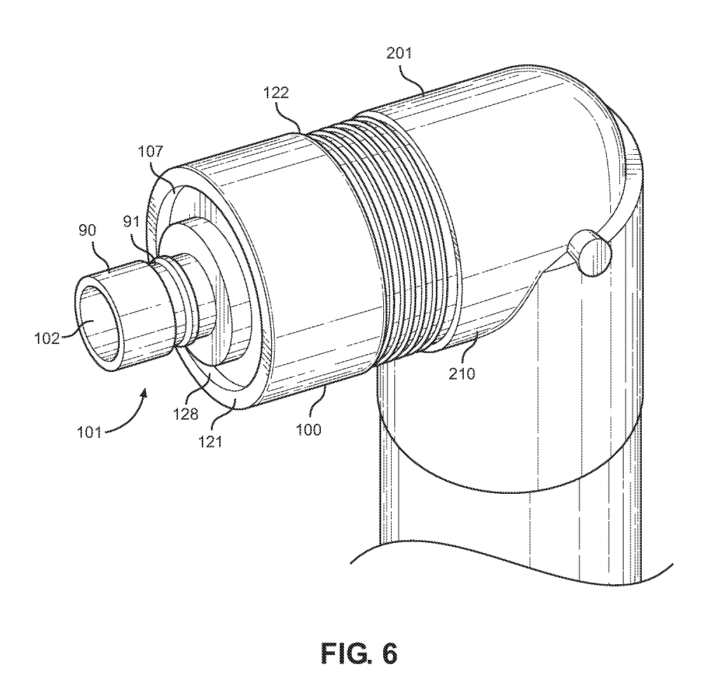

The pipe adapter 100 has a first end 122, a second end 121, and an optionally elongated body portion 120. The first end 122 of the pipe adapter 100 may have internal or external machine threads 129 therealong that are adapted to connect to a sink drain pipe 201 or couple to a collar nut 200 on the sink drain pipe 201. The sidewalls 123 of the pipe adapter 100 and the interior cross section 124 substantially align with the drain pipe sidewalls and cross section, whereby the pipe coupler 100 and drain pipe 201 secure together and are aligned to allow fluid to flow therethrough. The pipe adapter 100 therefore is chosen based on its size relative to the size of the drain pipe 201, whereby their sizes should be equal when fitting the two together. In one embodiment, the collar nut 200 of the drain pipe 201 secures to external threads along the first end 122 of the pipe adapter 100 (see FIG. 3). In another embodiment, the first end 122 of the pipe adapter 100 has internal threads that threadably connect to external threads along the end of the drain pipe 201 (see FIG. 6).

Referring to FIGS. 2 and 4, the second end 121 of the pipe adapter 100 has machine threads 128 adapted to connect to the machine threads 111 on the threaded cap 110 or machine threads 109 on the quick disconnect fitting 101. In the former case, the threaded cap 110 secure over the fitting 101 and threadably connects to the second end 121 of the pipe adapter 100 to sandwich the fitting 101 therebetween. In the latter case, the fitting 101 directly threads into the interior of the pipe adapter second end 121 without the use of a threaded cap 110. Once the fitting 101 and pipe adapter 100 are secured together and the pip adapter 100 is secured to the drain pipe 201, the elements are aligned in series and are sealed together such that fluid cannot leak therefrom when fluid is allowed to flow therethrough.

Referring now to FIG. 3, there is shown a view of an embodiment of the drain clearing kit of the present invention in a working state. The first end 122 of the pipe adapter 100 is secured to the drain pipe 102 via the drain pipe collar nut 200. The drain pipe 201 has a first end secured to the pipe adapter 100, and a second end 301 exiting through an adjacent wall 300. The quick disconnect fitting 101 is supported against the pipe adapter 100 via the threaded cap 110 along the second end 121 of the pipe adapter 100. Once secured, a water hose 400 with a complimentary fitting 402 along its end 401 is secured to the quick disconnect fitting 101 of the assembly. Thereafter, water can be turned on within the hose to allow pressurized water to enter the pipe adapter and drain pipe. The pressurized water flows downstream until encountering the clog. The force of the water pressure is used to break up and clear the clog downstream and within the drain pipe interior.

Referring now to FIGS. 4-5, the pipe adapter 100 comprises a body portion 120, a first end 122, and a second end 121. The first end 122 and second end 121 have internal machine threads 129, 128 that are adapted to couple the pipe adapter 100 to the drain pipe and to the quick disconnect fitting 101. Within the interior of the pipe adapter 100 is an internal ledge 135 that separates the threads 129 of the first end 122 from the threads 128 of the second end 121. In addition, a first and second gasket 130 is disposed between the internal ledge 135 and the ends of the adapter 100. The first gasket is disposed between the ledge 135 and the first end 122 of the adapter 100, while the second gasket 130 is disposed between the ledge 135 and the second end 121 of the adapter 100. This seals the adapter 100 to the drain pipe and to the fitting 101 when the elements are connected in series.

To couple the fitting 101 to the pipe adapter 100, the fitting 101 includes a widened proximal end 105 and an outer edge 103 along the proximal end 105. The outer edge 103 includes external machine threads 109 therealong that are adapted to threadably couple to the threads 128 of the second end 121 of the pipe adapter 100.Therefore, the fitting 101 and adapter 100 directly connect without using an intermediate threaded cap 110. Thereafter, the first end 122 of the pipe adapter 100 is threadably connected to a drain pipe with external threads and a hose can be connected to the plunger 90 of the fitting 101.

Referring now to FIG. 6, there is shown a view of the assembly connected to a drain pipe 201. A pipe adapter 100 is first selected based on the diameter of the drain pipe 201. The first end 122 of the pipe adapter 100 has an internal diameter and a thread pitch that must align with the drain pipe 201, therefore appropriate sizing is required. The kit may include one or more adapters 100. The first end 122 of the pipe adapter 100 is then threaded to the external threads 210 of the drain pipe 201. Thereafter, the quick disconnect fitting 101 is threadably attached to the second end 121 of the pipe coupler 100. The fitting 101 external threads engage the internal threads 109 along the second end 121 of the pipe coupler 100. Thereafter, a hose with a complimentary fitting can be secured to the plunger 90 and over the notch 91 of the fitting 101 to secure the hose to the fitting 101. Thereafter, fluid can be allowed to flow from the hose, through the opening 102 of the fitting, including coupler 100, and into the drain pipe 201 to clear a clog.

Overall, the method of clearing a clog includes the steps of securing an first end 122 of the pipe adapter 100 to sink drain pipe 201 either directly or using a threaded collar 200 to threadably secure the first end 122 of the pipe adapter 100 thereto. Then, a quick disconnect hose fitting 101 is secured to the threaded second end 121 of the pipe adapter 100 using either a threaded cap 110 having an interior shoulder or using internal threads along the coupler second end 121. The optional threaded cap 110 has threads that engage the threaded second end 121 of the pipe adapter 100, while the threaded cap 110 has a shoulder and an open interior. The shoulder of the threaded cap 110 secures the quick disconnect hose 101 fitting against the pipe adapter 100 while the quick disconnect hose fitting 101 extends through the open interior of the threaded cap 110. A gasket disposed between the fitting and the pipe adapter seals the two together. Finally, a fluid hose is affixed to the quick disconnect hose fitting 101, whereby the fluid hose has a complimentary fitting adapted to operably secure to the quick disconnect hose fitting 101. Finally, the method includes turning on a water supply to allow water to flow through the water hose, thereby forcing fluid through the fluid hose, through the quick disconnect hose fitting, into the pipe adapter, and into the sink drain to forcibly clear blockages therein.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A sink drain fitting kit that enables connection of a water line thereto, comprising:
a quick disconnect hose fitting that is adapted to couple to a complimentary fitting on a fluid hose without additional tools, thereby securing the fluid hose to the quick disconnect hose fitting when the quick disconnect hose fitting and the complimentary fitting are engaged;
the quick disconnect hose fitting having a male distal end, a widened proximal end, and a pathway therethrough;
a threaded cap having an interior shoulder, and an upstanding sidewall with interior threads;
the threaded cap having an open interior, whereby the distal end of the quick disconnect hose fitting extends therethrough, and the interior shoulder is sized to bear against the widened proximal end of the quick disconnect hose fitting;
an interior gasket between the threaded cap and the quick disconnect hose fitting;
a pipe adapter having a first end and a second end;
the first end of the pipe adapter having threads adapted to connect to a sink drain pipe;
the second end of the pipe adapter having exterior threads adapted to connect to the interior threads of the threaded cap.

2) The sink drain fitting kit of claim 1, wherein:
the first end of the pipe adapter has external threads adapted to connect to a collar on a sink drain pipe.

3) The sink drain fitting kit of claim 1, wherein:
the quick disconnect hose fitting further comprises an elongated plunger that is adapted to engage an interior of a compression fitting of the complimentary fitting;
whereby the plunger has a distal end with a notch therearound;
whereby the compression fitting secures the plunger therein and secures over the notch of the plunger.

4) A sink drain fitting kit that enables connection of a water line thereto, comprising:
a quick disconnect hose fitting that is adapted to couple to a complimentary fitting on a fluid hose without additional tools, thereby securing the fluid hose to the quick disconnect hose fitting when the quick disconnect hose fitting and the complimentary fitting are engaged;
the quick disconnect hose fitting having a male distal end, a widened proximal end, and a pathway therethrough;
the widened proximal end of the quick disconnect having an outer perimeter with external threads;
a pipe adapter having a first end, a second end, and a midsection;
the first end of the pipe adapter having threads adapted to connect to a sink drain pipe;
the second end of the pipe adapter having interior threads adapted to connect to the exterior threads of the quick disconnect hose fitting;
the midsection of the pipe adapter further comprising an internal ledge.

5) The sink drain fitting kit of claim 4, further comprising a gasket disposed along the internal ledge of the pipe adapter and the between the internal ledge and the second end thereof.

6) The sink drain fitting kit of claim 4, further comprising a gasket disposed along the internal ledge of the pipe adapter and the between the internal ledge and the first end thereof.

7) The sink drain fitting kit of claim 4, wherein the first end of the pipe adapter has interior threads adapted to connect to exterior threads of the sink drain pipe.

8) The sink drain fitting kit of claim 4, wherein:
the quick disconnect hose fitting further comprises an elongated plunger that is adapted to engage an interior of a compression fitting of the complimentary fitting;
whereby the plunger has a distal end with a notch therearound;
whereby the compression fitting secures the plunger therein and secures over the notch of the plunger.

9) A method of clearing a sink pipe drain using a water line, comprising the steps of:
selecting a pipe adapter sized to connect to a sink drain pipe;
threadably securing a first end of the pipe adapter to the sink drain pipe;
securing a threaded quick disconnect hose fitting to a threaded second end of the pipe adapter;
affixing a fluid hose to the quick disconnect hose fitting, whereby the fluid hose has a complimentary fitting adapted to operably secure to the quick disconnect hose fitting;
allowing fluid to flow through the fluid hose, through the quick disconnect hose fitting, into the pipe adapter, and into the sink drain to forcibly clear blockages therein.
